(19) United States
(12) Patent Application Publication
(10) Pub. No.: US 2007/0026282 A1
(43) Pub. Date: Feb. 1, 2007

(54) Polymer Electrolyte Membrane, Process For Production Thereof, Polymer Electrolyte, Electrolyte Composition, Membrane-Electrode Assembly, And Fuel Cell

(75) Inventors: Mamiko Kumagai, Tokyo (JP); Toru Nakakubo, Kawasaki-shi (JP); Kenji Yamada, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/459,559

(22) Filed: Jul. 24, 2006

(30) Foreign Application Priority Data
Jul. 26, 2005 (JP) 2005-216255(PAT.)

(51) Int. Cl. H01M 8/10

(52) U.S. Cl. 429/30; 429/33

(57) ABSTRACT

The polymer electrolyte membrane of the present invention is constituted of a block copolymer having an ion-conductive block. In the membrane, the ion-conductive block 12 forms ion-conductive domains 14 in a cylindrical shape arranged parallel to the thickness direction d of the polymer electrolyte membrane. The polymer electrolyte membrane has high ion conductivity, and capable of generating high output without humidification by a humidifier or at a low humidity.

### BACKGROUND OF THE INVENTION

1. Field of the Invention

The present invention relates to a polymer electrolyte membrane having a high ion conductivity, being less affected by humidity and temperature, and being suitable for a fuel cell; a process for producing the membrane; a membrane-electrode assembly employing the polymer electrolyte; and a fuel cell.

2. Description of the Related Art

Fuel cells are classified, according to the kind of the electrolyte employed, into polymer electrolyte types, phosphoric acid types, alkali types, molten carbonate types, solid oxide types, and so forth. Of these, low-temperature-working fuel cells, especially polymer electrolyte fuel cell (PEFC) are useful owing to less restriction in the fuel cell-constituting material and possibility for a smaller size and a lighter weight. Therefore, they are promising for portable small power sources, automobile power sources, and so forth. However, PEFCs for portable device still have problems for a higher power performance and a smaller size.

First problems concern with improvement of the electrolyte membrane for higher ion conductivity and higher strength. Generally, PEFCs employ a polymer electrolyte membrane formed from a non-crosslinked perfluoro type electrolyte membrane typified by Nation® (DuPont Co.) or formed from a hydrocarbon type electrolyte. For a higher power of such a PEFCs, the polymer electrolyte membrane has preferably a higher ion conductivity. Further, since the fuel cell is constructed from a stack of many single cells, the polymer electrolyte membrane is preferably thinner for miniaturization of the PEFCs, which necessitates the higher strength of the polymer membrane.

However, generally in a polymer membrane, ion-exchange groups distribute at random, and therefore, the electric resistance is higher at the regions of a lower density of the ion-exchange group. A polymer membrane having ionic exchange groups at a low density cannot give a high ion conductivity. Although the ion conductivity of the polymer membrane can be increased by increasing the density of the ion-exchange groups, the increase of the ion-exchange group density above a certain limit will make the polymer membrane water-soluble to lower the strength of the polymer membrane. Therefore, in the polymer membrane, the high ion conductivity and the high strength cannot readily be achieved simultaneously.

To solve the above problems with conventional PEFCs, efforts are made generally to increase the density of the ion-exchange group in the polymer membrane with the strength of the polymer membrane maintained by composite formation or crosslinking. For example, Japanese Patent Application Laid-Open No. 6-231779 (Patent Document 1) discloses a perfluoro type electrolyte composite film which is formed from a porous support made of randomly oriented fibers and an ion-conductive polymer impregnated therein for dimensional stability and handle ability.

For simultaneous achievement of the high ion conductivity and the high strength, a polymer electrolyte membrane is disclosed in which the sites for incorporation of an ion-conductive substance are fixed to obtain a high ion conductivity even with a relatively small amount of the ion-exchange groups.

For example, Japanese Patent Application Laid-Open No. 2002-203576 (Patent Document 2) discloses a polymer electrolyte membrane constructed from a supporting membrane having continuous pores penetrating through the membrane in a thickness direction and an ion-conductive substance introduced into the continuous pores. The continuous pores penetrating in the thickness direction through the porous support assigns the sites of the introduction of the ion-conductive substance. Thus a polymer electrolyte membrane having a high ion conductivity for a PEFC can be produced even with a relatively small amount of introduction of the ion exchange group.

Second problems concern with improvement for prevention of dry-out of the electrolyte membrane and prevention of flooding of the electrode. Any of the known materials for an electrolyte membrane for the PEFCs requires water for achieving the ion transfer.

In driving under dry conditions, the electrolyte membrane of the fuel cell will lose water to cause the so-called dry-out to lower the output power.

To solve this problem, in a conventional PEFC generally, water is replenished to the electrolyte membrane from the outside by an humidifier. Known methods for replenishing water to the electrolyte membrane include specifically humidification of a reaction gas by use of a bubbler, a mist generator, or a like means; direct injection of water into the reaction gas flow path formed in a separator; and so forth.

In the PEFCs, water is formed by the cell reaction, and the formed water migrates to the cathode side together with the migrating ions from the anode side to the cathode side by electro-osmotic drag. This will cause uneven water distribution in the electrolyte membrane, tending to cause excessive water accumulation in the cathode. This excessive water is liable to fill the pores in the electrode (occurrence of flooding) to lower the power of the fuel cell.

To prevent the drop of performance caused by the non-uniform water distribution, an electrolyte membrane is wanted in which the ion conductivity is not affected by the humidity conditions.

To solve the above problem, Japanese Patent Application Laid-Open No. 2003-031232 (Patent Document 3) discloses a polymer electrolyte membrane for fuel cells constituted of a block copolymer having a block containing sulfonic acid groups and a block containing no sulfo group. Specifically, a sulfonated aromatic polyether sulfone type block copolymer is employed which has a hydrophilic segment containing a sulfo group and a hydrophobic segment having no sulfo group. The polymer electrolyte membrane has an ion conductivity not lower than that of the polymer electrolyte containing sulfonic groups incorporated randomly. This membrane is reported to have a high water-resistance since the water content can be reduced. The ion conductivity of this polymer electrolyte is less affected by humidity and temperature.

The above-mentioned prior art techniques have disadvantages below.

Firstly, the above Patent Document 1 employs a composite film as the electrolyte membrane constituted of a porous supporting membrane constituted of randomly oriented fibers and an ion-conductive polymer impregnated therein. The pores in the porous supporting membrane are oriented at random, so that only a portion of the introduced ion-exchange group serves effectively for the ion transfer. Therefore for high ion conductivity, a larger amount of ion-conductive polymer should be introduced into the porous supporting membrane. However, for keeping the strength of the composite film, the porosity cannot be increased so much, and therefore with such a composite film, the increase of the ion conductivity is limited.

Secondly, the aforementioned Patent Document 2 employs a polymer electrolyte membrane constituted of a supporting membrane having continuous pores penetrating through the membrane in a thickness direction and an ion conductive substance introduced into the continuous pores. Thus a polymer electrolyte membrane having high ion-conductivity can be provided even with a relatively small amount of introduction of the ion exchange group. However, from the electrolyte membrane prepared by impregnating an ion-conductive substance into a porous supporting membrane, the ion-conductive substance introduced therein can be flow out with migration of water or swelling since the electrolyte membrane is a composite composed of two different substances of an ion-conductive substance and a supporting membrane, and has problems in contact with the electrode or long-term durability of the fuel cell. Further, modification of the continuous pores with ion-conductive substance does not improve the gas barrier properties and can not increase the introduction of the ion-exchange group, not improving to improve further the ion conductivity, since the density of the ion-exchanging substance in the supporting membrane is low.

Thirdly, in the case where the electrolyte is humidified by use of a humidifier, various components are necessary, such as a water tank for storing the water for humidification, a humidifier, a condenser for recovering water discharged from the fuel cell, and so forth. Thereby the fuel cell system is necessarily complicated and larger, disadvantageously. Further, the humidifier for humidification of the electrolyte requires additional power supply to lower the power-generating efficiency of the fuel cell. On the other hand, in the PEFCs, water is formed by cell reaction in the cathode side. If the formed water can be utilized directly for the humidification of the electrolyte, the humidification of the electrolyte by the humidifier can be reduced or omitted, which will contribute the miniaturization and weight-reduction of the entire fuel cell and the increase of the cell efficiency.

However, conventional electrodes for PEFCs are usually designed to facilitate discharge of water accumulated in the electrode to prevent power drop by flooding, such as treatment for hydrophobic treatment of the pore surface in the electrode. This makes impossible the effective utilization of the formed water. For stable driving of the cell, water content should be controlled by humidification by a humidifier. This hinders the miniaturization of the fuel cells.

Fourthly, the above-mentioned Patent Document 3 employs a sulfonated aromatic polyether sulfone type of block copolymer formed from a hydrophilic segment containing a sulfonic acid group and a hydrophobic segment not containing a sulfonic group. This membrane has an ion conductivity less affected by humidity and temperature. In such a block copolymer, the hydrophilic segment having a sulfonic acid group and the hydrophobic segment having no sulfonic acid group are separated by phase separation to form micro-domains, but the micro-domains are directed randomly. Therefore the improvement of the ion-conduction efficiency in this method is limited.

### SUMMARY OF THE INVENTION

On the background mentioned above, the present invention intends to provide a polymer electrolyte membrane which has a high ion-conductivity and capable of generating stably a high power without need for humidification of the electrolyte by a humidifier or under low humidity conditions, and provide also a process for producing the polymer electrolyte membrane.

The present invention intends also to provide a small-sized and low-temperature-working fuel cell for portable device.

The present invention intends further to provide a polymer electrolyte, an electrolyte composition, and a membrane-electrode assembly.

According to an aspect of the present invention, there is provided a polymer electrolyte membrane comprised of a block copolymer having an ion-conductive block, wherein the ion-conductive block forms ion-conducting cylindrical domains, arranged parallel to the thickness direction of the polymer electrolyte membrane. The ion-conductive block is preferably composed of a polymer having an ion-exchange group.

Alternatively, the ion-conductive block is preferably contained at a volume fraction ranging from 5% to 30% in the block copolymer. In the polymer electrolyte membrane, a main chain of the block copolymer preferably does not contain an aromatic ring.

The ion-conductive block has preferably a repeating unit selected from the group of chemical formulas (1) to (3) below: 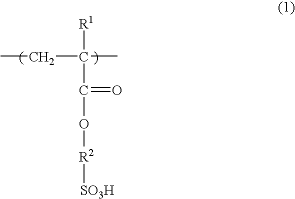
(in the formula, R¹ denotes a hydrogen atom or methyl, and R² denotes alkylene or arylene) 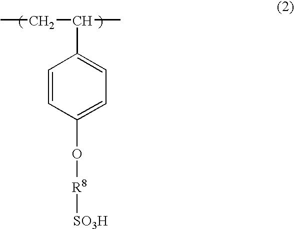
(in the formula, R³ denotes alkylene or arylene) 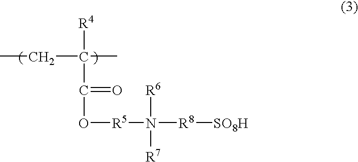
(in the formula, R⁴ denotes a hydrogen atom or methyl; R⁵ and R⁸ denote alkylene or arylene; and R⁶ and R⁷ may be the same or different and denote respectively a hydrogen atom or an organic group of 1-3 carbon atoms).

According to another aspect of the present invention, there is provided a membrane-electrode assembly, comprising the polymer electrolyte membrane and electrodes provided on both faces of the electrolyte membrane. The ion-conductive components are preferably arranged in a direction perpendicular or nearly perpendicular to the electrode face.

According to a still another aspect of the present invention, there is provided a fuel cell, comprising at least the membrane-electrode assembly having the polymer electrolyte membrane, and a collecting electrode. The ion-conducting components are preferably arranged in a direction perpendicular or nearly perpendicular to the electrode face.

According to a further aspect of the present invention, there is provided a polymer electrolyte membrane, comprising a block copolymer comprising an ion-conductive block and a non-ion-conductive block, the ion-conductive block being contained at a volume fraction ranging from 5% to 30%, and the non-ion-conductive block having a polymer chain with crosslinked structure. The ion-conductive block preferably constitutes ion-conducting cylindrical domains, arranged parallel to thickness direction of the electrolyte membrane. The main chain of the block copolymer preferably contains no aromatic ring.

According to a further aspect of the present invention, there is provided a polymer electrolyte, comprising a block copolymer comprising an ion-conductive block and a non-ion-conductive block, the ion-conductive block being contained at a volume fraction ranging from 5% to 30%, and the non-ion-conductive block having a repeating unit containing at least one crosslinking group. In the polymer electrolyte, a main chain of the block copolymer preferably contains no aromatic ring.

According to a further aspect of the present invention, there is provided an electrolyte composition, comprising
(A) a polymer electrolyte comprising a block copolymer, comprising an ion-conductive block and a non-ion-conductive block, the non-ion-conductive block having a repeating unit having at least one crosslinking group, and the ion-conductive block being contained at a volume fraction ranging from 5% to 30%, and
(B) a radical-generator. The main chain of the block copolymer preferably contains no aromatic ring.

According to a further aspect of the present invention, there is provided a process for producing a polymer electrolyte membrane, comprising steps of forming a membrane of a block copolymer comprising an ion-conductive block, and orienting cylindrical domains formed from the ion-conductive block in the block copolymer membrane, uniaxially parallel to thickness direction of the polymer electrolyte membrane. The process preferably further comprises a step of crosslinking side chains of the non-ion-conductive block of the block copolymer. The cylindrical domains are preferably oriented uniaxially by a heat treatment and external field application.

Such a crosslinked structure may be formed by a crosslinking group contained in the polymer before the crosslinking, or may be formed by addition of a crosslinking agent.

The radical-generator is preferably a photosensitive radical-generator

The radical-generator is preferably a thermal radical-generator. The membrane-electrode assembly for solving the aforementioned problems has an electrode on each face of the polymer electrolyte membrane.

The ion-conductive components of the polymer electrolyte membrane are preferably arranged in a direction nearly perpendicular to the electrode face.

The fuel cell for solving the above problem has a membrane-electrode assembly having an electrode on each face of the polymer electrolyte membrane.

The ion-conducting components of the polymer electrolyte membrane are preferably arranged in a direction perpendicular to the electrode face.

In the aforementioned invention, the main chain of the block copolymer does not have an aromatic ring.

Further features of the present invention will become apparent from the following description of exemplary embodiments (with reference to the attached drawings).

### BRIEF DESCRIPTION OF THE DRAWINGS

FIG. 1 illustrates schematically an embodiment of a polymer electrolyte membrane of the present invention.

FIG. 2 illustrates schematically an embodiment of the block copolymer of the present invention.

FIG. 3 is an AFM image of a micro-phase separation structure of a block copolymer of the present invention.

FIG. 4 illustrates schematically a constitution of a fuel cell.

### DESCRIPTION OF THE EMBODIMENTS

Embodiments of the present invention are explained below in detail by reference to drawings.

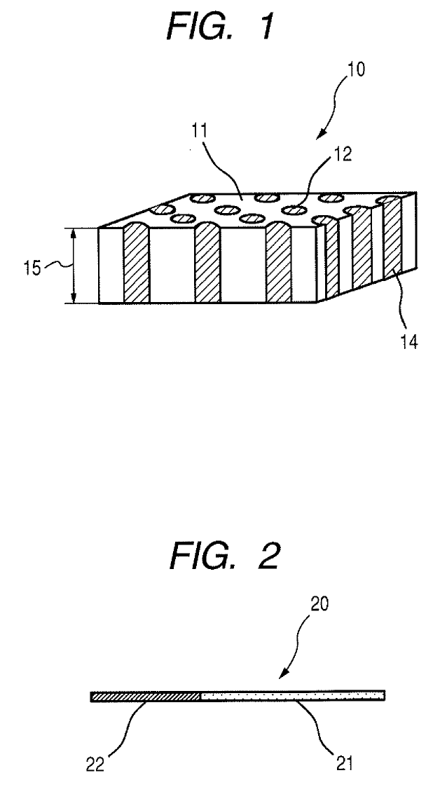

FIG. 1 illustrates schematically an embodiment of a polymer electrolyte membrane of the present invention. In FIG. 1, a polymer electrolyte membrane 10 (hereinafter referred to simply as a electrolyte membrane occasionally) is formed from an ion-conductive block. The membrane is formed by phase separation of the block copolymer into a matrix 11 as the film-supporting region, and ion-conductive region 12 constituted of cylindrical domains 14 formed from the ion-conductive blocks, the ion-conductive regions 12 being arranged in such cylinders parallel to the direction of thickness 15 of the membrane. The cylindrical domains need not be formed in uniform arrangement in just the same direction, but may be directed nearly the same directions within an angle range of 5° or less. The cylindrical domains are preferably not branched.

FIG. 2 illustrates schematically an embodiment of the block copolymer of the present invention. Block copolymer 20 is a copolymer constituted of an ion-conductive block 22 (hereinafter referred to as an “ion-conductive polymer” occasionally) composed of an ion-conductive polymer and a matrix block 21 (hereinafter referred to as a “matrix polymer” occasionally) composed of a matrix polymer forming a film-supporting matrix.

In electrolyte membrane 10, ion-conductive regions 12 are arranged in a state of cylinders in matrix 11. The diameter of the cylindrical domain 14 is usually within the range from 1 nm to 100 nm, but is not limited thereto.

The diameter of cylindrical domain 14 depends on the molecular weight of the ion-conductive polymer and the molecular weight of the matrix polymer. The number-average molecular weight (Mn) of the block copolymer is generally in the range from 1,000 to 1,000,000, but is not limited thereto.

The shape of ion-conductive regions 12 is not limited, insofar as the regions are oriented nearly parallel to the thickness direction of the electrolyte membrane. For example, the cylinders may incline at an angle less than 90° to the membrane thickness direction. The cylinder may be linear or zigzag. That is, the cylinders should be oriented nearly parallel to the membrane thickness direction. Further, the shape of the cross-section of the ion-conductive regions may be circular, ellipsoidal, or wavy irregularly, provided that it is formed by micro-phase separation.

The block copolymer for forming electrolyte membrane 10 is constituted of an ion-conductive polymer for forming ion-conductive block 22 and a matrix polymer for forming matrix block 21.

The source material for the matrix polymer is not limited, insofar as the block copolymer can be synthesized and the membrane can be constructed.

The matrix polymers include polymers synthesized from usual monomers having no ion-exchange group such as acrylate esters, methacrylate esters, styrene derivatives, conjugated dienes, and vinyl esters. Specifically the matrix polymers include polystyrene, polymethyl methacrylate, and polytrifluoroethyl methacrylate. Further, the monomers for forming the matrix polymer include styrene, α-, o-, m-, or p-substituted styrenes having alkyl, alkoxyl, halo, haloalkyl, nitro, cyano, amide, or ester; polymerizable unsaturated aromatic compounds such as 2,4-dimethylstyrene, p-dimethylaminostyrene, vinylbenzyl chloride, vinylbenzaldehyde, indene, 1-methylindene, acenaphthalene, vinylnaphthalene, vinylanthracene, vinyl carbazole, 2-vinylpyridine, 4-vinylpyridine, and 2-vinylfluorene; alkyl(meth)acrylates such as methyl(meth)acrylate, ethyl(meth)acrylate, n-propyl acrylate, n-butyl acrylate, 2-ethylhexyl(meth)acrylate, and stearyl(meth)acrylate; unsaturated monocarboxylic acid esters such as methyl crotonate, ethyl crotonate, and methyl cinnamate, and ethyl cinnamate; fluoroalkyl(meth)acrylates such as trifluoroethyl(meth)acrylate, pentafluoropropyl(meth)acrylate, and heptafluorobutyl(meth)acrylate; siloxanyl compounds such as trimethylsiloxanyldimethylsilylpropyl(meth)acryalte, tris(trimethylsiloxanyl)silylpropyl(meth)acryalte, and di(meth)acryloylpropyldimethylsilyl ether; hydorxyalkyl(meth)acrylates such as 2-hydroxyethyl(meth)acrylate, 2-hydroxypropyl(meth)acrylate, and 3-hydroxypropyl(meth)acrylate; amino-containing (meth)acrylates such as dimethylaminoethyl(meth)acrylate, diethylaminoethyl(meth)acrylate, and t-butylaminoethyl(meth)acrylate; hydroxyalkyl esters of unsaturated carboxylic acids such as 2-hydroxyethyl crotonate, 2-hydroxypropyl crotonate, and 2-hydroxypropyl cinnamate; unsaturated alcohols such as (meth)allyl alcohol; unsaturated (mono)carboxylic acids such as (meth)acrylic acid, crotonic acid, and cinnamic acid; epoxy-containing (meth)acrylate esters such as glycidyl(meth)acrylate, glycidyl α-ethylacrylate, glycidyl α-n-propylacrylate, glycidyl α-n-butylacrylate, 3,4-epoxybutyl(meth)acrylate, 6,7-epoxyheptyl(meth)acrylate, 6,7-epoxyheptyl α-ethylacrylate, o-vinylbenzyl glycidyl ether, m-vinylbenzyl glycidyl ether, p-vinylbenzyl glycidyl ether, β-methyglycidyl(meth)acrylate, β-ethylglycidyl(meth)acrylate, β-propylglycidyl(meth)acrylate, β-methylglycidyl α-ethylacrylate, 3-methyl-3,4-epoxybutyl(meth)acrylate, 3-ethyl-3,4-epoxybutyl(meth)acrylate, 4-methyl-4,5-epoxypentyl(meth)acrylate, 5-methyl-5,6-epoxyhexyl(meth)acrylate, β-methylglycidyl(meth)acrylate, and 3-methyl-3,4-epoxybutyl(meth)acrylate; and mono- and di-esters thereof; N-alkyl-substituted(meth)acrylamides such as N,N-dimethylacrylamide, and N-isopropylacrylamide; N-methylolacrylamide, N-methylolmethacrylamide, and vinylpyrrolidone; unsaturated polycarboxylic acids (anhydrides) such as maleic acid (ahhydride), fumaric acid, itaconic acid (anhydride), and citraconic acid; and vinyl chloride, and vinyl acetate.

The ion-conductive polymer has preferably a low glass transition temperature (Tg) for facilitating the formation of the cylindrical structure, and for control of the orientation structure of the cylinder. For the same reason, the ion-conductive polymer has preferably the main chain formed from an aliphatic hydrocarbon (not having aromatic ring in the main chain). The aliphatic hydrocarbon herein includes aliphatic hydrocarbons having a moiety substituted by an atom or atoms other than an aromatic ring. For example, a methylene group of the main chain may be substituted by an oxygen atom, or a group of NH, carbonyl, carboxyl, or amido. Otherwise, the main chain may have a substituted or unsubstituted alicyclic hydrocarbon group such as a cyclohexylene group or a maleimide structure. The main chain may have a double bond or a triple bond.

As described later, the membrane strength can be increased by incorporation of a functional group crosslinkable by light irradiation or another method.

The ion-conductive polymer is not limited insofar as the polymer has an ion-exchange group and is capable of synthesizing a block copolymer. The quantity of the ion- exchange group is selected for forming the cylinder structure.

The ion-conductive polymer for constituting the ion-conductive region should be capable of synthesizing the block copolymer. The ion-exchange group contained in the ion-conductive polymer is not limited, and is selected suitably for the purpose. Particularly preferred ion- exchange groups include groups of sulfonic acid, carboxylic acid, phosphoric acid, phosphonic acid, and hypophosphonic acid. The polymer may contain one or more kinds of ion-exchange group.

The preferred sulfonic acid group-containing monomers are exemplified by the ones produced by addition of a sulfonic acid group to the aforementioned diene monomer or olefin monomer, including specifically sulfonic acid (salt)-containing styrene, sulfonic acid (salt)-containing (meth)acrylater sulfonic acid (salt)-containing (meth)acrylamide, sulfonic acid (salt)-containing butadiene, sulfonic acid (salt)-containing isoprene, sulfonic acid (salt)-containing ethylene, and sulfonic acid (salt)-containing propylene. For improvement of strength and dimensional stability, or for clear phase-separation structure of the electrolyte membrane, a fluorine atom or atoms may be introduced to the above monomers, the fluorine-containing monomer being exemplified by ethylene-tetrafluoroethylene-styrene sulfonic acid, perfluorocarbonsulfonic acids, perfluorocarbonphosphonic acid, and trifluorostyrenesulfonic acid.

The ion-conductive polymer having a sulfonic acid group as the ion-exchange group has preferably any of the repeating units represented by the structural formulas (1) to (3). These structures may be employed singly or in combination of two or more thereof as the component of the ion-conductive block. 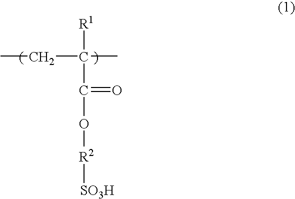
(in the formula, R¹ denotes a hydrogen atom or methyl, and R² denotes an alkylene or arylene) 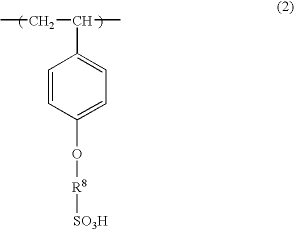
(in the formula, R³ denotes an alkylene or arylene) 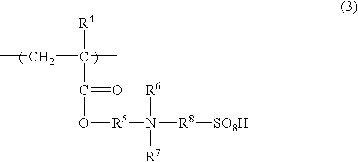
(in the formula, R⁴ denotes a hydrogen atom or methyl; R⁵ and R⁸ denote on alkylene or arylene; and R⁶ and R⁷ may be the same or different and denote respectively a hydrogen atom or an organic group of 1-3 carbon atoms).

Examples of the substituent groups in the above Chemical Formulas (1) to (3) are shown below.

The alkylene includes methylene, ethylene, propylene, and butylenes.

The arylene includes phenylene, naphthylene, and biphenylene.

The organic groups of 1-3 carbon atoms include methyl, ethyl, n-propyl, and isopropyl.

A block copolymer causes phase separation spontaneously into micro-domains of the components by self-assembly of the respective components. However, unlike macro-phase separation of water and oil, since the respective component blocks are fixed in one polymer chain, the phase separation is restricted by the size of the molecule to be in a size of several to about 100 nanometers. The phase-separated morphology varies depending on the compositional ratio and miscibility of the components to a state of spheres, cylinders, or lamellas. The sizes of the micro-domains can be controlled by the chain lengths and the miscibility. In the present invention, for formation of cylindrical domains in the electrolyte membrane, the block copolymer contains the ion-conductive block preferably at a volume fraction ranging from 5% to 30%.

Such a block copolymer in a solution is formed into a membrane, and the formed membrane is heat-treated at a temperature higher than the glass transition temperatures (Tg) of the both components (polymers) to undergo the thermodynamically equilibrated micro-domain structure at this temperature (formation of the phase separation structure). In this process, an external field is applied additionally to arrange the micro-phase separation structure in one direction (uniaxial orientation). In the present invention, the “external field” signifies an electric field, a magnetic field, shearing, and the like. For example, during the heat treatment of the polymer electrolyte membrane, an external field such as an electric field, a magnetic field, and shearing is applied for the uniaxial orientation. With the external field applied, the heat treatment may be conducted at a temperature lower than Tg.

In the present invention, “the structure of ion-conductive regions 12 arranged in cylinders” signifies a structure of the block copolymer constituted of an ion-conductive region and a matrix-forming region in which the ion-conductive regions are oriented uniaxially cylindrically in the membrane thickness direction as the result of micro-phase separation. Specifically, in the preparation of the electrolyte membrane having ion-conductive regions oriented in the membrane thickness direction, a block copolymer having the ion-conductive polymer is synthesized, a membrane is formed therefrom, and heat-treated to obtain a phase-separation structure, and is treated for uniaxial orientation. In the case where the uniaxial orientation can be obtained without application of the external field, such a treatment for the uniaxial orientation is not necessary.

The structure in which the ion-conductive regions are oriented cylindrically uniaxially can be confirmed by examining an ultra-thin slice of the film stained with RuO₄ by transmission type electron microscopy (hereinafter TEM). Otherwise, the cylindrical uniaxial orientation of the ion-conductive regions can be confirmed by observation of the phase separation structure of the membrane surface by atomic force microscopy (hereinafter AFM).

The compositional ratio in the block copolymer having the ion-conductive region is not limited, provided that the cylindrical micro-phase separation can be obtained. The morphology of the micro phase separation structure like the cylinder structure depends not only the volume fraction of the components, but also on the solubility parameters (called a X-parameter in the art) and degree of polymerization of the both components. Therefore, the volume fractions are decided depending on the chemical structure of the block copolymer employed (miscibility of the both blocks) and the degree of polymerization. The volume fraction of the ion-conductive block (IB) in the block copolymer ranges generally from 5% to 30%, preferably from 10% to 30%. At a low IB volume fraction (about 20% or lower), the micro-phase separated structure tends to be spherical. However, this structure can be transformed into a cylindrical structure by heat treatment and external field application. Generally, at an IB volume fraction of less than 5%, the phase separation structure cannot readily formed, whereas at an IB volume fraction of higher than 30%, another type of phase separation (gyroidal or lamella) appears. The volume fraction herein signifies a fraction of the volume of the block chain in one molecule chain of the block copolymer. Incidentally, the volume of each of the block can be obtained from the molecular weight and the specific gravity.

The molecular weight (Mn) of the ion-conductive polymer constituting the block copolymer ranges generally from 2,000 to 500,000, but is not limited thereto. The molecular weight (Mn) of the matrix polymer ranges generally 1,000 to 400,000, but is not limited thereto.

The synthesis process of the block copolymer is not limited. The process depends on the kind of the monomer:
(1) an ion-conductive polymer containing an ion-exchange group is firstly synthesized, and then a matrix polymer is copolymerized thereto;
(2) a matrix polymer is firstly synthesized, and then an ion-conductive polymer containing an ion-exchange group is copolymerized;
(3) an ion-conductive polymer containing an ion-exchange group, and a matrix polymer are synthesized separately and the two polymers are copolymerized to form a block copolymer; or
(4) a block copolymer is synthesized and thereto an ion exchange group is introduced thereto.

The process for synthesis of the block copolymer is not limited, provided that the intended block copolymer can be obtained. Other process includes, for example, living polymerization, and reaction of a hydrophobic segment prepolymer and a hydrophilic segment prepolymer having an ion-exchange group to obtain a copolymer. The process can be suitably selected for the object.

By living polymerization as the block copolymer synthesis, the degree of polymerization of the block chains can be controlled arbitrarily. The living polymerization process includes living anionic polymerization, living cationic polymerization, coordination polymerization, and living radical polymerization. Of these polymerization processes, living radical polymerization is preferred, but is not limited thereto.

Various methods of living radical polymerization have been developed recently. Examples are mentioned below: Iniferter polymerization (Macromol. Chem. Rapid Commun. 1982, vol. 3, p. 133); polymerization by use of a radical scavenger like a nitroxide compound (Macromolecules, 1994, vol. 27, p. 7228); atom transfer radical polymerization (ATRP) using an organic halide or a like compound as the initiator and employing a transition metal complex as the catalyst (J. Am. Chem. Soc., 1995, vol. 117, p. 5614); RAFT (reversible addition fragmentation chain transfer polymerization) as shown in Macromolecules, 1998, vol. 31, p. 5559; and so forth. Various vinyl monomers can be polymerized by such a polymerization process.

An embodiment of the present invention is a polymer electrolyte composed of a block copolymer containing a matrix polymer 21 having a polymerizable functional group on its side chain for matrix formation for supporting the electrolyte membrane. From this block copolymer, an electrolyte membrane having improved mechanical strength of the entire membrane can be obtained by membrane formation, and reaction of the polymerizable functional group to crosslink only the non-ion-conductive matrix region 11. Specifically, for the crosslinking, a matrix polymer A having a polymerizable functional group on the side chain thereof and a radical-generator B are mixed to prepare a composition; after formation of a membrane of this composition, the polymerizable functional groups on the side chains of the component A are intra- or inter-molecularly crosslinked by the radicals generated by the radical-generator B by photochemical reaction or thermal reaction.

The matrix polymer A having the polymerizable on the side chain is not limited, provided that it has one or more ethylenic unsaturated group as the polymerizable functional group in one molecule and is capable of reacting with a radical generated by the component B by photochemical reaction or thermal reaction for crosslinking after the membrane formation.

The polymerizable functional group of such a compound includes those having an ethylenic unsaturated group such as a vinyl group and a (meth)acryl group and being reactive in radical polymerization. The polymerizing functional group introduced into the side chain of the matrix polymer enables crosslinking reaction between the side chains of the matrix polymer after membrane formation to improve remarkably the mechanical strength of the membrane.

The radical-polymerizable ethylenic unsaturated group to be contained in the polymer side chain may be any of functional groups of radical-polymerizable monomers. The radical polymerizable monomers include vinyl aromatic monomers such as styrene, α-methylstyrene, 2-vinylstyrene, and 4-vinylstyrene; α,β-unsaturated carboxylic acids and derivatives thereof such as acrylic acid, metharylic acid, itaconic acid, maleic acid, fumaric acid, crotonic acid, methyl methacrylate, butyl methacrylate, 2-ethylhexyl methacrylate, ethyl acrylate, butyl acrylate, isooctyl acrylate, octadecyl acrylate, cyclohexyl acrylate, tetrahydrofurfuryl methacrylate, phenyl acrylate, phenethyl acrylate, benzyl methacrylate, β-cyanoethyl acrylate, maleic anhydride, diethyl itaconate, acrylamide, methacrylonitrile, and N-butylacrylamide; vinyl esters of carboxylic acid such as vinyl acetate, and vinyl 2-ethylhexanoate; vinyl halides such as vinyl chloride, and vinylidene chloride; N-vinyl compounds such as N-vinylpyrrolidone, N-vinylcaprolactam, and N-vinylcarbazole; and vinyl ketones such as methyl vinyl ketone.

The method for introducing the ethylenic unsaturated group into the polymer side chain is not limited. The unsaturated-group-containing polymer may be prepared by polymerization of a monomer containing an ethylenic unsaturated group on the side chain. Otherwise, after synthesis of a polymer, an ethylenic unsaturated group may be introduced to the polymer side chain. In synthesis of a block copolymer by radical polymerization, since the ethylenic unsaturated group on the side chain can react to cause a side reaction, the latter method is preferred in which the polymer is synthesized and then the ethylenic unsaturated group is introduced into the polymer side chain.

The radical polymerization initiator (Component B) generates radicals under action of energy of light and/or heat to initiate and promote the polymerization of the ethylenic unsaturated group of the component A. In the present invention, the radical-generator is selected from known photopolymerization initiators and known thermal polymerization initiators.

The photosensitive radical polymerization initiator is selected from known compounds, including: benzoins such as benzoin, benzoin methyl ether, benzoin ethyl ether, benzoin propyl ether, and benzoin isobutyl ether; acetophenones such as acetophenone, 2,2-diethoxy-2-phenylacetophenone, 2,2-diethoxy-2-phenylacetophenone, 1,1-dichloroacetophenone, 2-hydroxy-2-methyl-phenylpropan-1-one, diethoxyacetophenone, 1-hydroxycyclohexyl phenyl ketone, 2-benzyl-2-dimethylamino-1-(4-morpholinophenyl)-butan-1-one, and 2-methyl-1-[4-(methylthio)phenyl]-2-morpholinopropan-1-one; anthraquinones such as 2-ethylanthraquinone, 2-t-butylanthraquinone, 2-chloroanthraquinone, and 2-aminoanthraquinone; thioxanthones such as 2,4-diethylthioxanthone, 2-isopropylthioxanthone, and 2-chlorothioxanthone; ketals such as acetophenone dimethyl ketal, and benzyl dimethyl ketal; benzophenones such as benzophenone, 4-benzoyl-4′-methyldiphenyl sulfide, and 4,4′-bismethylaminobenzophenone; phosphine oxides such as 2,4,6-trimethylbenzoyldiphenylphosphine oxide, and bis(2,4,6-trimethylbenzoyl)-phenylphosphine oxide; and s-triazines such as 2,4,6-tris(monochloromethyl)-s-triazine, 2,4,6-tris(dichloromethyl)-s-triazine, 2,4,6-tris(trichloromethyl)-s-triazine, and 2-methyl-4,6-bis(trichloromethyl)-s-triazine, but are not limited thereto.

Besides the photosensitive polymerization initiator, a thermal radical polymerization initiator may be added in consideration of hardening after the membrane formation by heat treatment. The thermal polymerization initiator may be selected suitably corresponding to the heat treatment temperature after the membrane formation. The preferred initiators include organic peroxides such as di-t-butyl peroxide, 2,5-dimethyl-2,5-di(t-butylperoxy)hexane, 2,5-dimethyl-2,5-di(t-butylperoxy)hexyne-3,3,6,9-triethyl-3,6,9-trimethyl-1,4,7-triperoxonane, 1,1,3,3-tetramethylbutyl hydroperoxide, diisopropylbenzene monohydroperoxide, t-butyl hydroperoxide, t-amyl hydroperoxide, dicumyl peroxide, t-butylcumyl peroxide, diisopropylbenzene monohydroperoxide, and di(t-butylperoxyisopropyl)benzene.

A membrane is formed from a solution of a composition composed of (A) the block copolymer having an ethylenic unsaturated group on the side chain and (B) the radical-generator, and the matrix block 21 is crosslinked. Thereby, the membrane strength is improved, and the structure formed by self-assembled phase separation of the block copolymer is fixed. As the result, the cylindrical proton-conductive structure is stabilized to achieve stable proton conductivity.

Specifically, the aforementioned solution of the composition is applied on a substrate to form a coating membrane. The membrane may be formed by a coating method such as spin coating, immersion, roll coating, spraying, and casting. The polymer electrolyte membrane of the present invention prepared as above has ion-conductivity improved by uniaxial orientation of the cylindrical structure formed by micro-phase separation, while the crossinked matrix region has no ion-conductivity. For arranging the ion-conductive components cylindrically in the membrane thickness direction, the polymer electrolyte membrane before the crosslinking is subjected to application of external field like an electric field during the heat treatment to orient uniaxially the micro-phase separation structure. Further the oriented polymer electrolyte membrane is treated for crosslinking by radical generation by light irradiation or heating to crosslink the matrix block.

In the process of the light irradiation, the irradiated light includes ultraviolet rays such as i-ray of 365 nm, h-ray of 404 nm, g-ray of 436 nm, and wide wavelength region light like xenon lamp light; far-ultraviolet light such as KrF excimer laser beam of 248 nm, and ArF excimer laser beam of 193 nm; visible light; and mixed light thereof. The light is selected according to the chemical structure of the radical-generator B. Of these, ultraviolet light and visible light is preferred. The illuminance depends on the wavelength of the irradiated light, ranging preferably from 0.1 mW/cm² to 100 mW/cm² in view of the reaction efficiency.

On the other hand, for generating the radicals from the radical-generator B, a radical-generator is preferred which decomposes at a temperature higher than the heating temperature for forming the phase separation structure of the block copolymer. With a radical-generator which generates radicals at a low temperature, the crosslinking can occur before the ion-conductive regions are arranged cylindrically in the membrane thickness direction to prevent the formation of the uniaxially oriented electrolyte membrane.

For causing crosslinkage only in the non-ion-conductive matrix region 11, a crosslinking agent may be employed. The crosslinking agent is useful whether the block copolymer contains an ethylenic unsaturated group or not. In the former case, the crosslinking agent comes to be bonded to the ethylenic unsaturated groups on the side chain of the block copolymer to stabilize the phase-separation structure and to increase the mechanical strength. In the latter case, the crosslinking agent forms a fine network structure; the block copolymer is incorporated in the fine network formed by the crosslinking agent; and the network restricts the mobility of the polymer chains to stabilize the structure and to increase the mechanical strength.

The preferred crosslinking agents have two or more of radically polymerizable ethylenic unsaturated groups in the molecule. Any of conventional polymerizable compounds having the ethylenic unsaturated groups for the crosslinking is useful without particular limitation. The compound having two ethylenic unsaturated groups in the molecule is exemplified by ethylene glycol di(meth)acrylate, propylene glycol di(meth)acrylate, 1,4-butanediol di(meth)acrylate, neopentyl glycol di(meth)acrylate, 1,3-dioxolane di(meth)acrylate, 1,6-hexanediol di(meth)acrylate, glycerin di(meth)acrylate, polyethylene oxide di(meth)acrylate, polypropylene oxide di(meth)acrylate, tricyclodecane dimethylol di(meth)acrylate, bisphenol-A di(meth)acrylate, polyoxyethylene-bisphenol-A di(meth)acrylate, polyoxyethylene-bisphenol-F di(meth)acrylate, polyoxyethylene-bisphenol-S di(meth)acrylate, polyoxypropylene-bisphenol-A di(meth)acrylate, polyoxypropylene-bisphenol-F di(meth)acrylate, polyoxypropylene-bisphenol-S di(meth)acrylate, methylene-bis-acrylamide, N,N′-acryloylethylenediamine, N,N′-acryloylpropylenediamine, divinylbenzene, diallyl phthalate, allyl acrylate, and allyl methacrylate.

The compound having three ethylenic unsaturated groups in the molecule is exemplified by trimethylolpropane triacrylate, pentaerythritol triacrylate, polyoxyethylene-trimethylolpropane triacrylate, polyoxypropylene-trimethylolpropane triacrylate, N,N′,N″-trihydroxyethyl-1,3,5-triazine-2,4,6-trione triacrylate, glycerin triacrylate, polyoxyethylene-glycerin triacrylate, trimethylolpropane trimethacrylate, and pentaerythritol trimethacrylate.

The compound having four or more ethylenic unsaturated groups in the molecule is exemplified by pentaerythritol tetraacrylate, ditrimethylolpropane tetraacrylate, dipentaerythritol hexaacrylate, polyhydroxy-oligoester polyacrylate, polyhydroxy-oligourethane polyacrylate, pentaerythritol tetramethacrylate, ditrimethylol propane tetramethacrylate, dipentaerythritol hexamethacrylate, and polyhydroxy-oligoester polymethacrylate.

Such a polymerizable compound having ethylenic unsaturated group may be used singly or in combination of two or more thereof as the crosslinking agent.

The crosslinking agent has preferably a structure which tends to localize to the hydrophobic segment (non-ion-conductive matrix segment), having hydrophobic chemical structure. Among the above-mentioned crosslinking agents, those having high hydrophobicity are 1,6-hexanediol di(meth)acrylate, tricyclodecane dimethylol di(meth)acrylate, bisphenol-A di(meth)acrylate, polyoxyethylene-bisphenol-A di(meth)acrylate, polyoxyethylene-bisphenol-F di(meth)acrylate, polyoxyethylene-bisphenol-S di(meth)acrylate, polyoxypropylene-bisphenol-A di(meth)acrylate, polyoxypropylene-bisphenol-F di(meth)acrylate, polyoxypropylene-bisphenol-S di(meth)acrylate, divinylbenzene, polyoxypropylene-trimethylolpropane triacrylate, and N,N′,N″-trihydroxyethyl-1,3,5-triazine-2,4,6-trione triacrylate, but the crosslinking agent is not limited thereto.

In the membrane composed of the two components of the block copolymer and the additional crosslinking agent as a third component, the crosslinking agent will localize in the matrix portion to change the volume fractions of the hydrophilic portion (ion-conductive block) and the hydrophobic portion (matrix block+crosslinking agent) from those in the original block copolymer. Therefore, for obtaining the intended nano-metric membrane structure (cylindrical structure, etc.), the volume fractions in the block copolymer and the amount of the crosslinking agent are adjusted.

Next, the function of the electrolyte membrane of an embodiment of the present invention is explained below. In the electrolyte membrane of the present invention, the ion-conductive region composed of ion-conductive polymer and the matrix polymer forming the membrane structure are separated into phases. Owing to this phase-separation, the ion-conductive region contributes more effectively to the ion conductivity. Further, owing to the high water content of the ion-conductive region even at a lower humidity, the electrolyte membrane has high ion conductivity with less influence of the humidity. The matrix polymer region, which does not cause change of the shape by the water content of the membrane, achieves stable dimensional stability, high strength, and high ion conductivity simultaneously.

Further, in the aforementioned electrolyte membranes the ion-conductive regions are oriented nearly parallel to the membrane thickness direction, and therefore the ion-conductive regions connect the electrodes on the both faces of the electrolyte membrane at the shortest ion transfer paths. This improves further the conduction efficiency to give higher ion conductivity. Further, the water diffusion rate is increased in the ion-conductive region to distribute uniformly and quickly the water formed in the cathode in the membrane. Thereby the drying of the membrane can be prevented even at low humidity with the ion conductivity kept independent of the humidity.

A membrane-electrode assembly of an embodiment of the present invention can be prepared by placing an electrode on each face of the polymer electrolyte membrane. This membrane-electrode assembly is constituted of a polymer electrolyte membrane of the present invention and catalytic electrodes (anode and cathode) placed on the both faces of the electrolyte membrane. The catalytic electrodes have a catalytic layer on the respective gas diffusion layers. The assembly can be prepared by any conventional technique. For example, a gas diffusion electrode is directly formed which has platinum, a platinum-ruthenium alloy, or fine particles thereof as the catalyst deposited on a carrier such as carbon; the gas-diffusion electrodes and the polymer electrolyte membrane are hot-pressed; or they are bonded by an adhesive.

A fuel cell can be produced with the polymer electrolyte membrane of the present invention and the above-mentioned membrane-electrode assembly. An example of the fuel cell is constituted of the membrane-electrode assembly, a pair of separators holding the membrane-electrode assembly, collecting electrodes attached to the separators, and packings. An anode-side opening is provided at the separator on the anode side to feed a gas or liquid fuel such as hydrogen, and alcohol like methanol. A cathode-side opening is provided at the separator on the cathode side to feed oxidant gas such as oxygen and air. In a passive type fuel cell, the separator at the oxidant gas side may be omitted.

FIG. 4 shows an example of a unit of the fuel cell prepared as above. In FIG. 4, the numerals denote the members as follows: 41, a collecting electrode; 42, a separator; 43, a gas diffusion layer; 44, a catalyst layer; 45, a polymer electrolyte membrane; 46, a packing; 47, an arrow indicating the air feed direction; H₂, an arrow indicating the H₂ feed direction. Incidentally, a gas flow path made of a foamed metal may be provided in place of separator 42 or between the separator and gas diffusion layer 43.

By using the aforementioned polymer electrolyte membrane as the constituting member, the fuel cell can be made smaller, since the fuel cell is capable of outputting high power over a long term even at a low humidity or without humidification of the electrolyte by an humidifier. The polymer electrolyte membrane having the crosslinked matrix region of the present invention has improved mechanical strength and dimensional stability, and can prevent swelling of the membrane by moisture and prevent methanol permeation in the fuel cell using the methanol as the direct fuel.

### EXAMPLE

The present invention is explained specifically by reference to Examples without limiting the invention thereto in any way. Firstly polymers were prepared by the procedures shown below.

### Synthesis Example 1

### Synthesis of Poly(Styrenesulfonic Acid)-b-Polystyrene (BP-2)

(The Symbol “b” Denotes that the Polymer is a Block Copolymer.)

In a 20-mL Schlenk tube, were placed 5.5 g of ethyl styrenesulfonate, 30 μL of 1-bromoethylbenzene, 5.5 g of dimethylformamide, 85 μL of 1,1,4,7,10,10-hexamethyltriethylenetetramine, and 45 mg of catalyst CuBr. The dissolved oxygen in the mixture solution was purged with nitrogen. The polymerization was allowed to proceed at 100° C. for 5 hours. The resulting polymer was reprecipitated from toluene to obtain polymer-A. The polymer-A had a number-average molecular weight (Mn) of 24,200 according to gel permeation chromatography (GPC) in DMF.

In another 20-mL Schlenk tube, were placed 1.5 g of styrene monomer, 0.5 g of the above-obtained polymer-A, 1.5 g of dimethylformamide, 10 μL of 1,1,4,7,10,10-hexamethyltriethylenetetramine, and 5 mg of catalyst CuBr. The polymerization was allowed to proceed at 110° C. for 5 hours to obtain a block copolymer BP-1 (poly(ethyl styrenesulfonate)-b-polystyrene). The block copolymer BP-1 had a number-average molecular weight (Mn) of 82,100 according to gel permeation chromatography (GPC) in DMF.

To the obtained block copolymer BP-1, were added an aqueous 1.5M ammonium carbonate solution and dimethylformamide. The mixture was refluxed to deprotect the ethyl ester to obtain the intended block copolymer, poly(styrenesulfonic acid)-b-polystyrene (BP-2). The volume fraction of polystyrenesulfonic acid in BP-2 was found to be 29%. The structural formula of the block copolymer BP-2 is shown below.

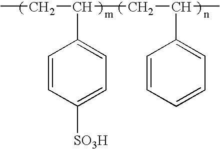

### Synthesis Example 2

### Synthesis of Poly(Styrenesulfonic Acid)-b-Poly(Trifluoroethyl Methacrylate): (BP-4)

In a 20-mL Schlenk tube, were placed 5.5 g of ethyl styrenesulfonate, 30 μL of 1-bromoethylbenzene, 5.5 g of dimethylformamide, 85 μL of 1,1,4,7,10,10-hexamethyltriethylenetetramine, and 45 mg of catalyst CuBr. The dissolved oxygen in the mixture solution was purged with nitrogen. The polymerization was allowed to proceed at 100° C. for 5 hours. The resulting polymer was reprecipitated from toluene to obtain a polymer-B. The polymer-B had a number-average molecular weight (Mn) of 24,200 according to gel permeation chromatography (GPC) in DMF.

In another 20-mL Schlenk tube, were placed 3.0 g of trifluoroethyl methacrylate, 1.0 g of the above-obtained polymer-B, 3.0 g of dimethylformamide, 16 μL of 1,1,4,7,10,10,-hexamethyltriethylenetetramine, and 11.7 mg of catalyst CuBr. The polymerization was allowed to proceed at 110° C. for 3 hours to obtain a block copolymer BP-3 (poly(ethyl styrenesulfonate)-b-poly(trifluoroethyl methacrylate)). The block copolymer BP-3 had a number-average molecular weight (Mn) of 81,420 according to gel permeation chromatography (GPC) in DMF.

To the obtained block copolymer BP-3, were added an aqueous 1.5M ammonium carbonate solution and dimethylformamide. The mixture was refluxed to deprotect the ethyl ester to obtain the intended block copolymer, poly(styrenesulfonic acid)-b-poly(trifluoroethyl methacrylate) (BP-4). The volume fraction of polystyrenesulfonic acid in BP-4 was found to be 27%. The structural formula of the block copolymer BP-4 is shown below.

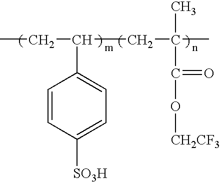

### Synthesis Example 3

### Synthesis of Poly(Styrenesulfonic Acid)-b-Poly(Methyl Methacrylate) (BP6)

In a 20-mL Schlenk tube, were placed 8 g of styrene monomer, 51 μL of 1-bromoethylbenzene, 202 μL of 1,1,4,7,10,10-hexamethyltriethylenetetramine, and 100 mg of catalyst CuEr. The dissolved oxygen in the mixture solution was purged with nitrogen. The polymerization was allowed to proceed at 110° C. for 2 hours. The reaction mixture is diluted with toluene, and the resulting polymer was precipitated with methanol to obtain polymer-C. The polymer-C had a number-average molecular weight (Mn) of 19,100 according to gel permeation chromatography (GPC) in DMF.

In another 20-mL Schlenk tube, were placed 2.0 g of methyl methacrylate, 1.0 g of the above-obtained polymer-C, 4 mL of anisole, 19.5 μL of 1,1,4,7,10,10-hexamethyltriethylenetetramine, and 14.3 mg of catalyst CuBr. The polymerization was allowed to proceed at 80° C. for 10 hours to obtain a block copolymer BP-5 (poly(methyl methacrylate)-b-polystyrene). The block copolymer BP-5 had a number-average molecular weight (Mn) of 68,520 according to gel permeation chromatography (GPC) in DMF.

A 5 g portion of dioxane is placed in a reaction vessel. Thereto 0.5 g of sulfuric anhydride was added by keeping the inside temperature at 25° C., and the mixture was stirred for two hours to obtain a (sulfuric anhydride)-dioxane complex. In another reaction vessel, 1.3 g of the block copolymer BP-5 was dissolved in 4.0 of 1-tetrahydrofuran. Thereto, the above (sulfuric anhydride)-dioxane complex was added by keeping the inside temperature at 25° C., and the mixture was stirred for two hours to sulfonate only the polystyrene portion to obtain BP-6 (poly(styrenesulfonic acid)-b-poly(methyl methacrylate)). The volume fraction of polystyrenesulfonic acid in BP-6 was found to be 29%. The structural formula of the block copolymer BP-6 is shown below.

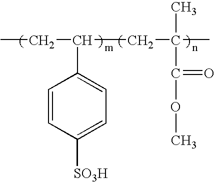

### Synthesis Example 4

### Synthesis of Poly(Styrenesulfonic Acid)-r-Polystyrene: (RP-2)

(The Symbol “r” Denotes that the Polymer is a Random Copolymer.)

In a 20-mL Schlenk tube, were placed 2.5 g of ethyl styrenesulfonate, 4.5 g of styrene monomer, 2.5 g of dimethylformamide, and 60 mg of azoisobutyronitrile. The polymerization was allowed to proceed at 100° C. for two hours. The resulting polymer was reprecipitated from toluene to obtain a random copolymer (RP-1). The copolymer RP-1 had a number-average molecular weight (Mn) of 100,000 according to gel permeation chromatography (GPC) in DMF.

To the obtained random copolymer RP-1, were added an aqueous 1.5M ammonium carbonate solution and dimethylformamide. The mixture was refluxed to deprotect the ethyl ester to obtain the intended random copolymer, poly(styrenesulfonic acid)-r-polystyrene (RP-2). The volume fraction of polystyrenesulfonic acid in RP-2 was found to be 28%.

### Example 1

The block copolymer BP-2 obtained in Synthesis Example 1 having sulfonic acid groups as the ion-exchange group was dissolved in dimethylformamide at a solid concentration of 20 wt %. This solution was applied on a Pt substrate by dip coating to form a membrane of 30 μm thick. On the membrane, another Pt substrate was placed to sandwich the membrane in a state of Pt/(BP-2)/Pt, and this Pt/(BP-2)/Pt assemblage was heated under application of an electric field of 40 V/μm at 160° C. for 10 hours to complete the electrolyte membrane.

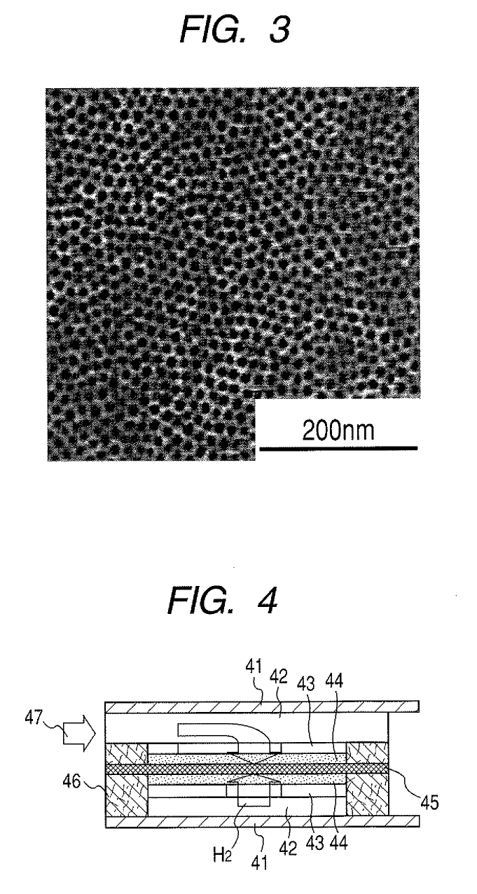

FIG. 3 shows a result of AFM observation of the surface of the obtained electrolyte membrane. As shown clearly in FIG. 3, the membrane surface had a dot pattern. The volume fraction of the polystyrenesulfonic acid segment of BP-2 was found to be 27%. At such a volume fraction, the ion-conductive polystyrenesulfonic acid portion is known to form a cylindrical micro-domain structure. Therefore, the dot pattern observed on the membrane surface shows a cross-section of the cylindrical structure, showing the uniaxial orientation of cylinders of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.02 S·cm⁻¹ at 50° C. and relative humidity of 50%.

### Example 2

The block copolymer BP-4 obtained in Synthesis Example 2 was dissolved in dimethylformamide at a solid concentration of 20 wt %. This solution was applied on a Pt substrate by dip coating to form a membrane of 30 μm thick. On the membrane, another Pt substrate was placed to sandwich the membrane in a state of Pt/(BP-4)/Pt, and this Pt/(BP-4)/Pt assemblage was heated under application of an electric field of 40 V/μm at 160° C. for 10 hours to complete the electrolyte membrane. The AFM observation result showed uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.02 S·cm⁻¹ at 50° C. and relative humidity of 50%.

### Example 3

The block copolymer BP-6 obtained in Synthesis Example 3 was dissolved in dimethylformamide at a solid concentration of 20 wt %. This solution was applied on a Pt substrate by dip coating to form a membrane of 30 μm thick. On the membrane, another Pt substrate was placed to sandwich the membrane in a state of Pt/(BP-6)/Pt, and this Pt/(BP-6)/Pt assemblage was heated under application of an electric field of 40 V/μm at 160° C. for 10 hours to complete the electrolyte membrane. The AFM observation result showed uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.03 S·cm⁻¹ at 50° C. and relative humidity of 50%.

### Comparative Example 1

The block copolymer BP-2 obtained in Synthesis Example 1 was dissolved in dimethylformamide at a solid concentration of 20 wt %. This solution was applied on a Pt substrate by dip coating to form a membrane of 30 μm thick. The membrane was dried on a hot plate at 70° C. for 5 minutes. This membrane was subjected neither to long-time heat treatment nor to orientation treatment by an external field application. The AFM observation result showed disordered phase-separation in the membrane into ion-conducting components and matrix portions in a sea-island structure.

The obtained electrolyte membrane was measured for resistance by pressing the electrolyte membrane between platinum plates by a two-terminal method under application of alternate current at a frequency of 1 kHz. The ion conductivity was found to be 0.005 S·cm⁻¹ at 50° C. and relative humidity of 50%.

### Comparative Example 2

The block copolymer BP-2 obtained in Synthesis Example 1 was dissolved in dimethylformamide at a solid concentration of 20 wt %. This solution was applied on a Pt substrate by dip coating to form a membrane of 30 μm thick. This substrate was heated at 160° C. for 10 hours to obtain an electrolyte membrane. This membrane was not treated for the external field application although it was heat-treated as above. The AFM observation result showed disordered phase-separation in the membrane into ion-conducting components and matrix portions in a sea-island structure.

The obtained electrolyte membrane was measured for resistance by pressing the electrolyte membrane between platinum plates by a two-terminal method under application of alternate current at a frequency of 1 kHz. The ion conductivity was found to be 0.007 S·cm⁻¹ at 50° C. and relative humidity of 50%.

### Comparative Example 3

The copolymer RP-2 obtained in Synthesis Example 4 was dissolved in dimethylformamide at a solid concentration of 20 wt %. This solution was applied on a Pt substrate by dip coating to form a membrane of 30 μm thick as an electrolyte membrane. This membrane was constituted of a random copolymer, not a block copolymer No phase-separation structure was confirmed by AFM observation.

The obtained electrolyte membrane was measured for resistance by pressing the electrolyte membrane between platinum plates by a two-terminal method under application of alternate current at a frequency of 1 kHz. The ion conductivity was found to be 0.001 S·cm⁻¹ at 50° C. and relative humidity of 50%.

### Synthesis Example 5

### Synthesis of Block Copolymer (BP-8) Constituted of Sulfonic Acid-Containing Block Having Repeating Unit of Chemical Formula (1) and Polystyrene Block

In a nitrogen atmosphere, were mixed 0.3 mmol of copper bromide, 0.3 mmol of pentamethyldiethylenetriamine, 0.3 mmol of methyl 2-bromopropionate, and 45 mmol of t-butyl acrylate (tBA). The dissolved oxygen in the mixture was purged with nitrogen The mixture was allowed to react at 70° C. by monitoring the conversion by gas chromatography. The reaction was stopped by quenching the reaction mixture with liquid nitrogen. The obtained poly-tBA was found to have Mn=13,600 and Mw/Mn=1.07 according to GPC.

Then, 0.4 mmol of the obtained poly-tBA having bromine at the terminal, 0.4 mmol of copper bromide (I), 0.4 mmol of hexamethyltriethylenetetramine, and 800 mmol of styrene were mixed and the mixture was purged with nitrogen. The mixture was allowed to react at 100° C. The reaction was stopped by quenching with liquid nitrogen. The resulting polymer was purified by reprecipitation with methanol. The obtained block copolymer, PtBAb-PSt (BP-7), was found to have Mn=75,700 and Mw/Mn=1.18 according to GPC. From this, the molecular weights of the respective blocks were estimated to be 13,600 for the PtBA block, and 62,100 for the PSt block. This result was consistent with the block compositional ratio derived from the peak integral ratio in 1H-NMR.

The obtained block copolymer BP-7 was mixed with trifluoroacetic acid (5 equivalents to t-butyl group) at room temperature in tetrahydrofuran (THF) to eliminate the t-butyl group to deprotect the carboxylic group to obtain poly(acrylic acid)-b-polystyrene (PAA-b-PSt). This PAA-b-PSt was dissolved in THF, and thereto were added sodium hydride (10 equivalents to the carboxylic acid) and 1,3-propane-sultone (20 equivalents to the carboxylic acid). The mixture was refluxed to sulfonate the PAA segment. Thus a block copolymer (BP-8) was obtained which has an intended structure of Formula (1) as one component containing sulfonic acid group as an ion-exchange group. BP-8 contained the sulfonate-containing block at a volume fraction of 23%. The structural formula of the block copolymer BP-8 is shown below.

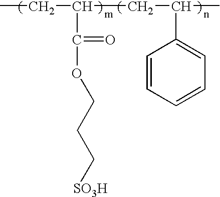

### Synthesis Example 6

### Synthesis of Block Copolymer (BP-10) Constituted of Sulfonic Acid-Containing Block Having Repeating Unit of Chemical Formula (2) and Poly(Hexafluoroisopropyl Acrylate)

In a nitrogen atmosphere, were mixed 0.6 mmol of copper(I) bromide, 0.6 mmol of hexamethyltriethylenetetramine, 0.3 mmol of 1-bromoethylbenzene, and 30 mmol of t-butoxystyrene (tBOS) The dissolved oxygen in the mixture was purged with nitrogen. The mixture was allowed to react at 110° C. by monitoring the conversion by gas chromatography. The reaction was stopped by quenching the reaction mixture with liquid nitrogen. The obtained poly-tBOS was found to have Mn=10,300 and Mw/Mn=1.12 according to GPC.

Then, 0.4 mmol of the obtained poly-tBOS having bromine at the terminal, 0.4 mmol of copper(I) bromide, 0.4 mmol of pentamethyldiethylenetriamine, and 100 mmol of 1,1,1,3,3,3-hexafluoroisopropyl acrylate (HFIPA) were dissolved and mixed in trifluorotoluene/anisole (2/1, v/v) as the solvent. The solution was purged with nitrogen. The mixture was allowed to react at 90° C. The reaction was stopped by quenching with liquid nitrogen. The resulting polymer was purified by reprecipitation with methanol. The obtained block copolymer, PtBOS-b-PHFIPA (BP-9), was found to have Mn=48,100, and Mw/Mn=1.22 according to GPC. From this, the molecular weights of the respective blocks were estimated to be 10,300 for the PtBOS block, and 37,800 for the PHFIPA block. This result was consistent with the block compositional ratio derived from the peak integral ratio in 1H-NMR.

The obtained block copolymer BP-9 was allowed to react with 8.6N hydrobromic acid (3 equivalent to the t-butoxy group) in trifluorotoluene/1,4-dioxane (1/1, v/v) as the solvent at 60° C. Thereby the t-butoxy groups of the PtBOS segment were deprotected to change into the phenol groups to obtain polyvinylphenol-b-poly(hexafluoroisopropyl acrylate) (PVPh-b-PHFIPA). This PVPh-b-PHFIPA was dissolved in THF, and thereto were added sodium hydride (10 equivalents to the hydroxyl group) and 1,4-butane-sultone (20 equivalents to the phenol). The mixture was refluxed to sulfonate the PVPh segment. Thus a block copolymer (BP-10) was obtained which has an intended structure of Formula (2) as one component containing sulfonic acid group as an ion-exchange group. BP-10 contained the sulfonic acid group-containing block at a volume fraction of 26%. The structural formula of the block copolymer BP-10 is shown below.

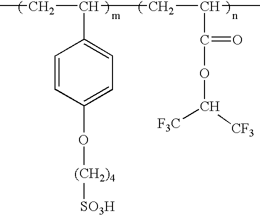

### Synthesis Example 7

### Synthesis of Block Copolymer (BP-12) Constituted of Sulfonic Acid-Containing Block Having Repeating Unit of Chemical Formula (3) and Poly(Trifluoroethyl Methacrylate)

In a nitrogen atmosphere, were mixed 0.2 mmol of copper bromide, 0.4 mmol of hexamethyltriethylenetetramine, 0.2 mmol of 2-ethylbromo isobutyrate, and 30 mmol of dimethylaminoethyl methacrylate (DMAMA). The dissolved oxygen in the mixture was purged with nitrogen. The mixture was allowed to react at 40° C. by monitoring the conversion by gas chromatography. The reaction was stopped by quenching the reaction mixture with liquid nitrogen. The obtained polyDMAMA was found to have Mn=12,200 and Mw/Mn=1.24 according to GPC.

Then, 0.3 mmol of the obtained polyDMAMA, 0.3 mmol of copper(I) bromide, 0.6 mmol of 4,4-dinonyl-2,2-bipyridyl, and 200 mmol of 2,2,2-trifluoroethyl methacrylate (TFEMA) were dissolved and mixed in trifluorotoluene/dimethylformamide (1/1, v/v) as the solvent. The solution was purged with nitrogen. The mixture was allowed to react at 80° C. The reaction was stopped by quenching with liquid nitrogen. The resulting polymer was purified by reprecipitation with methanol. The obtained block copolymer, PDMAMA-b-PTFEMA (BP-11), was found to have Mn=64,600, and Mw/Mn=1.21 according to GPC. From this, the molecular weights of the respective blocks were estimated to be 12,200 for the PDMAMA block, and 52,400 for the PTFEMA block. This result was consistent with the block compositional ratio derived from the peak integral ratio in 1H-NMR.

The obtained block copolymer BP-11 was allowed to react with 1,3-propanesultone (2 equivalents to the DMAMA unit) in trifluorotoluene/THF (1/1, v/v) as the solvent at 40° C. to sulfonate the PDMAMA segment. Thus a block copolymer (BP-12) was obtained which has an intended structure of Formula (3) as one component containing sulfonic acid group as an ion-exchange group. BP-12 contained the sulfonic acid group-containing block at a volume fraction of 28%. The structural formula of this block copolymer BP-12 is shown below.

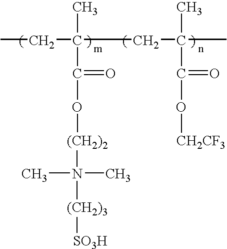

### Example 4

In this Example, an electrolyte membrane was prepared from a block copolymer having an ion-conductive segment having the repeating unit of Formula (1). The block copolymer BP-8 obtained in Synthesis Example 5 was dissolved in propylene glycol methyl ether acetate at a solid concentration of 15 wt %. This solution was applied on a Pt substrate by dip coating to form a membrane of 25 μm thick. On the membrane, another Pt substrate was placed to sandwich the membrane in a state of Pt/(BP-8)/Pt, and this Pt/(BP-8)/Pt assemblage was heated under application of an electric field of 30 V/μm at 100° C. for 10 hours. The AFM observation result showed micro-phase separation with uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.04 S·cm⁻¹ at 50° C. and relative humidity of 50%.

### Example 5

In this Example, an electrolyte membrane was prepared from a block copolymer having an ion-conductive segment having the repeating unit of Formula (2). The block copolymer BP-10 obtained in Synthesis Example 6 was dissolved in dimethylformamide at a solid concentration of 17 wt %. This solution was applied on a Pt substrate by dip coating to form a membrane of 25 μm thick. On the membrane, another Pt substrate was placed to sandwich the membrane in a state of Pt/(BP-10)/Pt, and this Pt/(BP-10)/Pt assemblage was heated under application of an electric field of 40 V/μm at 140° C. for 10 hours. The AFM observation result showed micro phase separation with uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.05 S·cm⁻¹ at 50° C. and relative humidity of 50%.

### Example 6

In this Example, an electrolyte membrane was prepared from a block copolymer having an ion-conductive segment having the repeating unit of Formula (3). The block copolymer BP-12 obtained in Synthesis Example 7 was dissolved in propylene glycol methyl ether acetate at a solid concentration of 22 wt %. This solution was applied on a Pt substrate by dip coating to form a membrane of 30 μm thick. On the membrane, another Pt substrate was placed to sandwich the membrane in a state of Pt/(BP-12)/Pt, and this Pt/(BP-12)/Pt assemblage was heated under application of an electric field of 40 V/μm at 140° C. for 10 hours. The AFM observation showed micro-phase separation with uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.04 S·cm⁻¹ at 50° C. and relative humidity of 50%.

### Synthesis Example 8

### Synthesis of Block Copolymer (BP-14) Constituted of Ion-Conductive Block having Repeating Unit of Chemical Formula (3) and Non-Ion-Conductive Block Having Polymerizable Functional Group on Side-Chain of Matrix-Forming Polymer Segment

In a nitrogen atmosphere, were mixed 0.35 mmol of copper chloride, 0.7 mmol of hexamethyltriethylenetetramine, 0.35 mmol of 2-ethylbromo isobutyrate, and 40 mmol of dimethylaminoethyl methacrylate (DMAMA). The dissolved oxygen in the mixture was purged with nitrogen. The mixture was allowed to react at 40° C. by monitoring the conversion by gas chromatography. The reaction was stopped by quenching the reaction mixture with liquid nitrogen. The obtained polyDMAMA was found to have Mn=9,400 and Mw/Mn=1.29 according to GPC.

Then, 0.3 mmol of the obtained polyDMAMA, 0.25 mmol of copper(I) bromide, 0.5 mmol of 4,4-dinonyl-2,2-bipyridyl, 200 mmol of 2-(trimethylsilyloxy)ethyl methacrylate (TMSOMA) were dissolved and mixed in dimethylformamide as the solvent. The solution was purged with nitrogen. The mixture was allowed to react at 70° C. The reaction was stopped by quenching with liquid nitrogen. The resulting polymer was purified by reprecipitation with methanol. The obtained block copolymer, PDMAMA-b-PTMSOMA (BP-13), was found to have Mn-58,300, and Mw/Mn=1.27 according to GPC. From this, the molecular weights of the respective blocks were estimated to be 9,400 for the PDMAMA block, and 48,900 for the PTSOMA block. This result was consistent with the block compositional ratio derived from the peak integral ratio in ¹H-NMR.

The obtained BP-13 was dissolved in THF, and this solution was mixed with aqueous 6N hydrochloric acid solution at room temperature to eliminate trimethylsilyl groups of the side chains of the PTMSOMA block to transfer the hydroxyl groups. The product was dissolved in THF, and was allowed to react with acrylic chloride in the presence of triethylamine to introduce acryl groups as the polymerizable functional groups to the side chains of the non-ion-conductive block.

Further, the block copolymer having acryl groups introduced to the side chains was allowed to react with 1,3-propane-sultone (2 equivalents to the DMAMA unit) in THF as the solvent at 40° C. to sulfonate the PDMAMA segment. Thus a block copolymer (BP-14) was obtained which contains structure of Formula (3) as the ion-conductive component and a matrix-forming polymer block having acryl groups on the side chains. BP-10 contained the sulfonic acid group-containing block at a volume fraction of 25%. The structural formula of the block copolymer BP-14 is shown below.

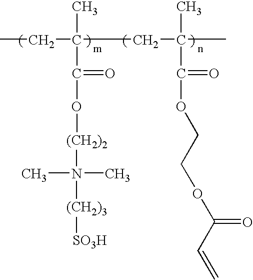

### Example 7

In this Example, an electrolyte membrane was formed through steps of preparing a block copolymer constituted of an ion-conductive block having the repeating unit of Formula (3) and non-ion conductive block having polymerizable functional groups; preparing an electroconductive composition comprising the block copolymer and a thermal radical-generator; forming a membrane of the composition; and crosslinking a matrix portion formed by phase separation.

A solution of an electrolyte composition was prepared by dissolving 25 weight parts of BP-14 obtained in Synthesis Example 8 and 8 weight parts of dicumyl peroxide as the thermal radical-generator in 100 weight parts of dimethylformamide.

The composition was formed into a membrane of 25 μm thick on a Pt substrate by dip coating. This substrate was heated at 110° C. for 10 hours to prepare an electrolyte membrane. In this electrolyte membrane, the non-ion-conductive matrix portion formed by phase separation came to be crosslinked by the heat treatment without application of an external field. Infrared spectrometry of the membrane after the heat treatment showed that the peak (1615 cm⁻¹) of the acryl group on the polymer side chain disappeared. This shows occurrence of the crosslinking reaction. The AFM observation result showed disordered phase-separation in the membrane into ion-conducting components and matrix portions in a sea-island structure.

The obtained electrolyte membrane was measured for resistance by pressing the electrolyte membrane between platinum plates by a two-terminal method under application of alternate current at a frequency of 1 kHz. The ion conductivity was found to be 0.008 S·cm⁻¹ at 50° C. and relative humidity of 50%.

The hardness of the electrolyte membrane was measured by nano-indentation method (Erionics Co., ENT-1100). The hardness of the crosslinked membrane of this Example was found to be 0.7 GPa, whereas the non-crosslinked membrane of Example 4 was found to be 0.2 GPa. The mechanical strength was found to be improved by the crosslinking.

### Example 8

In this Example, a block copolymer was used which has an ion-conducting component having the repeating unit shown by Formula (3) and a non-ion-conducting component having polymerizable functional groups. An electrolyte composition was prepared which contained the block copolymer and a photosensitive radical generator. A membrane was formed from the electrolyte composition. An electric field was applied to the membrane to orient uniaxially the ion-conducting components formed by micro-phase separation in the membrane thickness direction, and the non-ion-conductive matrix portion was crosslinked.

A solution of an electrolyte composition was prepared by dissolving 22 weight parts of BP-14 obtained in Synthesis Example 8, and 5 weight parts of 2-benzyl-2-dimethylamino-1-(4-morpholinophenyl)butan-1-one (Irgacure 369; Ciba Specialty Chemical Co.) as the photosensitive radical-generator in 100 weight parts of propylene glycol methyl ether acetate.

A membrane was formed from this composition solution on a Pt substrate by dip coating in a thickness of 20 μm. On the membrane, another Pt substrate was placed to hold the membrane in a state of Pt/(BP-14)/Pt, and an electric field was applied to this Pt/(BP-14)/Pt assemblage at 40 V/μm at 70° C. for 6 hours. Then the membrane was exposed to i-ray to cause crosslinking between the side chains of the matrix-forming polymer segment. Infrared spectrometry of the membrane after the i-ray exposure showed that the peak (1615 cm⁻¹) of the acryl group on the polymer side chain had disappeared. This showed occurrence of the crosslinking reaction. The AFM observation of the surface of the electrolyte membrane showed micro-phase separation structure with uniaxial orientation of the ion conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.03 S·cm⁻¹ at 50° C. and relative humidity of 50%.

The hardness of the electrolyte membrane was measured by nano-indentation method (Erionics Co., ENT-1100). The hardness of the crosslinked membrane of this Example was found to be 0.6 GPa, whereas the non-crosslinked membrane of Example 4 was found to be 0.2 GPa. Thus the mechanical strength was found to be improved by the crosslinking.

### Example 9

A membrane-electrode assembly and a fuel cell are produced through steps shown below.

As the powdery catalyst, HiSPEC1000® (Johnson & Massey Co.) was used. As the electrolyte solution, a solution of Nafion® (DuPont Co.) was used. Firstly, the powdery catalyst and the electrolyte solution were mixed to form a mixture liquid dispersion. This liquid dispersion was applied on a PTFE sheet by a doctor blade method to form a catalyst sheet. The prepared catalyst sheet was transferred, onto each face of the electrolyte membrane obtained by uniaxial orientation of BP-14 in Example 8, by a Decar method at 150° C. and 100 kgf/cm² to prepare a membrane-electrode assembly. This membrane-electrode assembly was sandwiched between carbon cloth electrodes (E-TEK Co.), and further this sandwiched assembly was held between collecting electrodes for connection to construct a fuel cell as shown in FIG. 4.

For operation of the fuel cell, hydrogen gas was fed to the anode side at an injection rate of 300 mL/m, and air was fed to the cathode side; the cell outlet pressure was kept atmospheric; the relative humidity was kept at 50% both at the anode and at the cathode; and the cell temperature was kept at 50° C. A discharge test was conducted at a current density of 400 MA/cm². The initial cell potential was 540 mV. This cell output performance was stable. After continuous driving for more than one week, the cell potential was changed little to be 99% of the initial potential.

### Comparative Example 4

A fuel cell was produced in the same manner as in Example 9 except that an electrolyte membrane was used which was formed from a random copolymer RP-2 synthesized in Synthesis Example 4. This fuel cell was driven under the same conditions as in Example 9 for testing the cell output stability. After driving for one week, the cell potential dropped greatly to 50% of the initial potential.

### Example 10

In this Example, a block copolymer was used which has an ion-conducting component having the repeating unit of Formula (1). An electrolyte composition was prepared which contained the block copolymer, a photosensitive radical-generator, and a crosslinking agent. A membrane was formed from the electrolyte composition. An electric field was applied to the membrane to orient uniaxially the ion-conducting component formed by micro-phase separation in the membrane thickness direction, and the non-ion-conductive matrix portion was crosslinked.

A solution of an electrolyte composition was prepared by dissolving 25 weight parts of BP-8 obtained in Synthesis Example 5, 7 weight parts of polyoxypropylene-bisphenol-A diacrylate as the crosslinking agent, and 5 weight parts of 2-benzyl-2-dimethylamino-l-(4-morpholinophenyl)butan-1-one (Irgacure 369; Ciba Specialty Chemical Co.) as the photosensitive radical generator in 100 weight parts of propylene glycol methyl ether acetate.

A membrane was formed from the above composition solution on a Pt substrate by dip coating in a membrane thickness of 30 μm. On the membrane, another Pt substrate was placed to hold the membrane in a state of Pt/(BP-8+crosslinking agent)/Pt, and an electric field was applied thereto at 40 V/μm at 70° C. for 6 hours. Then the membrane was exposed to i-ray to cause crosslink between the side chains of the matrix-forming polymer segment. Infrared spectrometry of the membrane after the light exposure showed that the peak (1613 cm⁻¹) of the acryl group on the polymer side chain had disappeared. This showed occurrence of the crosslinking reaction. The AFM observation of the surface of the electrolyte membrane showed micro-phase separation structure with uniaxial orientation of the ion-conducting components parallel to the membrane thickness direction.

The obtained electrolyte membrane was measured for resistance by pressing the electrolyte membrane between platinum plates by a two-terminal method under application of alternate current at a frequency of 1 kHz. The ion conductivity was found to be 0.03 S·cm⁻¹ at 50° C. and relative humidity of 50%.

The hardness of the electrolyte membrane was measured by nano-indentation method (Erionics Co., ENT-1100). The hardness of the crosslinked membrane of this Example was found to be 1.0 GPa, whereas the non-crosslinked membrane of Example 4 was found to be 0.2 GPa. The mechanical strength was found to be improved by the crosslinking.

According to a preferred embodiment of the present invention, ion-conducting components constituted of ion-conductive block of the block copolymer are separated by spontaneous phase separation in a membrane-structuring matrix of a polymer electrolyte membrane. Thereby, a high ion conductivity can be achieved with less influence of humidity and temperature.

Further, the ion-conducting components are oriented parallel to the thickness direction of the polymer electrolyte membrane to be arranged uniaxially, which improves the ion conductivity efficiency.

According to another preferred embodiment of the present invention, a fuel cell is provided which has a membrane-electrode assembly constituted of a polymer electrolyte membrane and electrodes bonded to both faces of the membrane. In this fuel cell, the ion-conducting components of the electrolyte are oriented parallel to the thickness direction of the polymer electrolyte membrane. This improves the rate of diffusion of water. A part of the water formed by the cell reaction at the electrode is diffused back to the electrolyte membrane and is re-utilized for humidifying the electrolyte. With this membrane structure in which the ion-conducting components are arranged parallel to the direction of the thickness of the membrane, the water can be uniformly distributed in the electrolyte membrane.

With this constitution of the polymer electrolyte membrane, the water content in the electrolyte membrane can be maintained at a level necessary for stable operation of the cell to prevent drop of the performance and to enable stable high output. Therefore, the power output is less liable to drop, even when the electrolyte is not humidified by a humidifier, humidified less, or even when water is not sufficiently fed at the start of the fuel cell or in a like case. Further with this constitution, high power output can be maintained stably for a long time, and the fuel cell can be miniaturized.

As described above, according to preferred embodiments of the present invention, a polymer electrolyte membrane and a process for producing the polymer electrolyte can be provided which gives high ion conductivity and enables stable high power output for long time even when the electrolyte is not humidified by a humidifier, or humidified less.

The polymer electrolyte membrane of the preferred embodiment of the present invention gives high ion conductivity and enables stable high power output for long time, even when the electrolyte is not humidified by a humidifier, or humidified less. Therefore, the polymer electrolyte membrane is useful for small fuel cells with low-temperature-working type of portable devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-216255, filed Jul. 26, 2005, which is hereby incorporated by reference herein in its entirety.

What is claimed is:

1. A polymer electrolyte membrane comprised of a block copolymer having an ion-conductive block, wherein the ion-conductive block forms ion-conducting cylindrical domains, arranged parallel to the thickness direction of the polymer electrolyte membrane.

2. The polymer electrolyte membrane according to claim 1, wherein the ion-conductive block is composed of a polymer having an ion-exchange group.

3. The polymer electrolyte membrane according to claim 1, wherein the ion-conductive block is contained at a volume fraction ranging from 5% to 30% in the block copolymer.

4. The polymer electrolyte membrane according to claim 1 wherein a main chain of the block copolymer does not contain an aromatic ring.

5. The polymer electrolyte membrane according to claim 1, wherein the ion-conductive block has a repeating unit selected from the group of chemical formulas (1) to (3) below: 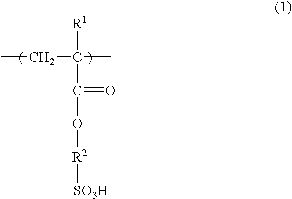
(in the formula, R¹ denotes a hydrogen atom or methyl, and R² denotes alkylene or arylene) 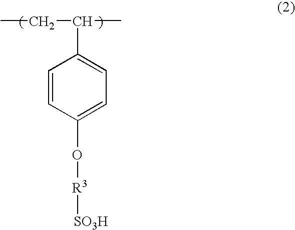
(in the formula, R³ denotes alkylene or arylene) 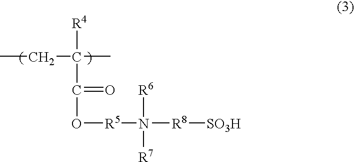
(in the formula, R⁴ denotes a hydrogen atom or methyl; R⁵ and R⁸ denote alkylene or arylene; and R⁶ and R⁷ may be the same or different and denote respectively a hydrogen atom or an organic group of 1-3 carbon atoms).

6. A polymer electrolyte membrane, comprising a block copolymer comprising an ion-conductive block and a non-ion-conductive block, the ion-conductive block being contained at a volume fraction ranging from 5% to 30%, and the non-ion-conductive block having a polymer chain with crosslinked structure.

7. The polymer electrolyte membrane according to claim 6, wherein the ion-conductive block constitutes ion-conducting cylindrical domains, arranged parallel to thickness direction of the electrolyte membrane.

8. The polymer electrolyte membrane according to claim 6, wherein the main chain of the block copolymer contains no aromatic ring.

9. A polymer electrolyte, comprising a block copolymer the ion-conductive block being contained at a volume fraction ranging from 5% to 30%, and the non-ion-conductive block having a repeating unit containing at least one crosslinking group.

10. The polymer electrolyte according to claim 9, wherein a main chain of the block copolymer contains no aromatic ring.

11. An electrolyte composition, comprising
(A) a polymer electrolyte comprising a block copolymer, the non-ion-conductive block having a repeating unit having at least one crosslinking group, and the ion-conductive block being contained at a volume fraction ranging from 5% to ³⁰%, and
(B) a radical-generator.

12. The electrolyte composition according to claim 11, wherein the main chain of the block copolymer contains no aromatic ring.

13. A process for producing a polymer electrolyte membrane, comprising steps of
forming a membrane of a block copolymer comprising an ion-conductive block, and
orienting cylindrical domains formed from the ion-conductive block in the block copolymer membrane, uniaxially parallel to thickness direction of the polymer electrolyte membrane.

14. The process for producing a polymer electrolyte membrane according to claim 13, wherein the process further comprises a step of crosslinking side chains of the non-ion-conductive block of the block copolymer.

15. The process for producing a polymer electrolyte membrane according to claim 13, wherein the cylindrical domains constituted of the ion-conductive block are oriented uniaxially by a heat treatment and external field application.

16. A membrane-electrode assembly, comprising the polymer electrolyte membrane set forth in claim 1 and electrodes provided on both faces of the polymer electrolyte membrane.

17. The membrane-electrode assembly according to claim 16, wherein the ion-conducting components in the polymer electrolyte membrane arranged in a direction perpendicular or nearly perpendicular to the electrode face.

18. A fuel cell, comprising at least the membrane-electrode assembly having the polymer electrolyte membrane set forth in claim 1, and a collecting electrode.

19. The fuel cell according to claim 18, wherein the ion-conducting components in the polymer electrolyte membrane are arranged in a direction perpendicular or nearly perpendicular to the electrode face.
